(19) United States
(12) Patent Application Publication
(10) Pub. No.: US 2025/0084843 A1
(43) Pub. Date: Mar. 13, 2025

(54) POWER END FRAME ASSEMBLY

(71) Applicant: BJ Energy Solutions, LLC, The Woodlands, TX (US)

(72) Inventor: Hau Nguyen-phuc Pham, The Woodlands, TX (US)

(73) Assignee: BJ Energy Solutions, LLC, The Woodlands, TX (US)

(21) Appl. No.: 18/463,950

(22) Filed: Sep. 8, 2023

(51) Int. Cl. F04B 53/16; F16J 10/00

(52) U.S. Cl. CPC F04B 53/16; F16J 10/00

(57) ABSTRACT

The present disclosure relates to power end frame assemblies having a plurality of bearing plates coupled together by a structural support. The frame assembly can include a plurality of bearing plates to support one or more components of a crankshaft assembly. Adjacent bearing plates of the frame assembly can form receptacles to accommodate a portion of one or more components of a crosshead assembly. The bearing plates of the frame assembly can have one or more openings to receive one or more structural supports. The one or more structural supports can couple together the plurality of bearing plates. Some configurations have bearing plates with portions that extend beyond the receptacle formed by adjacent bearing plates. In such configurations a structural support can couple the bearing plates via openings on these extended portions.

### FIELD OF DISCLOSURE

The present invention relates generally to power end frames for reciprocating pumps; and more particularly, but not by way of limitation, to a power end frame assembly having a plurality of bearing plates coupled together by one or more structural supports.

### BACKGROUND

Reciprocating pumps, also known as positive displacement pumps, are used in many applications and industries to convert mechanical energy into hydraulic energy. Reciprocating pumps generally include two sections: a power end and a fluid end. The power end is configured to move one or more plungers toward, and away from, the fluid end. The fluid end is where the pumping takes place—fluid is drawn in and forcibly pushed out at a high pressure by the plungers. When reciprocating pumps are, for example, in operation or transported strong forces act on the power end frame. Conventional power end frames have many stress points (e.g., numerous welds coupling each of the bearing plates to a supporting skid, platform, or base structure). Thus, conventional power end frames—or its components—may fail because of shear, bending, and torsion loads.

### SUMMARY

The present disclosure relates to power end frames having a plurality of bearing plates coupled together by a structural support. The frame assembly can include a plurality of bearing plates with openings to support one or more crankshaft assemblies. Adjacent bearing plates of the frame assembly can form receptacles to accommodate a portion of one or more components of a crosshead assembly. The bearing plates of the frame assembly can have one or more openings to receive one or more structural supports. The plurality of bearing plates can be coupled together by the one or more structural supports received by the one or more openings of the plurality of bearing plates. When the reciprocating pump is in operation, the structural support resists twisting of the bearing plates and undergoes loads in torsion, bending, and shear. These structural supports thus reinforce the frame assembly and may reduce the number of bearing plates that need to be connected (e.g., welded) to a supporting skid, platform, or base structure. In so doing, the number of stress points may be reduced, while the strength and performance of the power end frame and reciprocating pump are maintained and/or improved.

Some configurations of the present frame assembly comprise a plurality of bearing plates. In some configurations, each bearing plate comprises a body portion. In some configurations, the body portion comprises a first opening for receiving a portion of a crankshaft assembly. In some configurations, the body portion extends from a circumference of the first opening. In some configurations, each bearing plate comprises a receptacle portion. In some configurations, the receptacle portion is coupled to the body portion and extends in a first direction. In some configurations, each bearing plate comprises a base portion. In some configurations, the base portion is coupled to the body portion and extends in a second direction. In some configurations, the base portion comprises an extension portion. In some configurations, the extension portion extends beyond the circumference of the first opening. In some configurations, the base portion comprises a second opening for receiving a structural support. In some configurations, the second opening is at least partially positioned on the extension portion. In some configurations, the present frame assembly comprises a structural support. In some configurations, the structural support extends through the second opening of each of the plurality of bearing plates. In some configurations, the receptacle portions of adjacent bearing plates form receptacles to accommodate at least a portion of a crosshead assembly. In some configurations, the plurality of bearing plates are coupled together by the structural support.

In some configurations of the present frame assembly, the extension portion has a portion that extends beyond the receptacle portion. In some configurations, the second opening is positioned on the portion of the extension portion that extends beyond the receptacle portion.

In some configurations of the present frame assembly, the structural support is a first structural support. In some configurations, the base portion comprises a third opening for receiving a structural support. In some configurations, the present frame assembly comprises a second structural support. In some configurations, the second structural support extends through the third opening of each of the plurality of bearing plates. In some configurations, the plurality of bearing plates are coupled together by the second structural support. In some configurations, the third opening is positioned on the extension portion. In some configurations, the extension portion has a portion that extends beyond the receptacle portion. In some configurations, the third opening is positioned on the portion of the extension portion that extends beyond the receptacle portion.

In some configurations of the present frame assembly, the extension portion comprises a first extension portion. In some configurations, the first extension portion extends beyond the receptacle portion. In some configurations, the extension portion comprises a second extension portion. In some configurations, the second extension portion extends beyond the circumference of the first opening to the first extension portion. In some configurations, the structural support is a first structural support. In some configurations, the base portion comprises a third opening for receiving a structural support. In some configurations, the present frame assembly comprises a second structural support. In some configurations, the second structural support extends through the third opening of each of the plurality of bearing plates. In some configurations, the plurality of bearing plates are coupled together by the second structural support. In some configurations, the second opening is positioned on the second extension portion. In some configurations, the third opening is positioned on the first extension portion. In some configurations, the second and third openings are positioned on the first extension portion.

In some configurations of the present frame assembly, the structural support comprises a tubular beam. In some configurations, the tubular beam has a hollow body. In some configurations, the tubular beam has a circular cross-section.

In some configurations of the present frame assembly, each receptacle comprises a first crosshead plate. In some configurations, each receptacle comprises a second crosshead plate. In some configurations, the crosshead plates are coupled to the adjacent bearing plates that form the receptacle.

Some configurations of the present frame assembly comprise one or more crankcase casing plates. In some configurations, the crankcase casing plates correspond to respective receptacles formed by adjacent bearing plates of the present frame assembly. In some configurations, each crankcase casing plate is coupled to the first crosshead plate of the respective receptacle. In some configurations, each crankcase casing plate is coupled to the second crosshead plate of the respective receptacle. In some configurations, each crankcase casing plate is coupled to the adjacent bearing plates of the respective receptacle. In some configurations, each crankcase casing plate extends from the first crosshead plate to the second crosshead plate of the respective receptacle. In some configurations, each crankcase casing plate extends around the first opening of the adjacent bearing plates of the respective receptacle. In some configurations, each crankcase casing plate comprises one or more openings for allowing access to one or more components of a crankshaft assembly. In some configurations, each crankcase casing plate comprises one or more openings for allowing access to one or more components of a bearing assembly. In some configurations, each crankcase casing plate comprises one or more openings for allowing access to one or more components of a plunger assembly. In some configurations, each crankcase casing plate comprises one or more openings for allowing access to one or more components of a crosshead assembly.

Some configurations of the present frame assembly comprise a plurality of crossheads. In some configurations, each crosshead is at least partially positioned within a corresponding receptacle.

Some configurations of the present frame assembly comprise a plurality of plunger assemblies. In some configurations, each plunger assembly of the plurality of plunger assemblies comprises a plunger coupled to a crosshead of the plurality of crossheads. In some configurations, each plunger assembly of the plurality of plunger assemblies extends beyond the receptacle. In some configurations, each plunger assembly comprises a connecting rod coupled to the crosshead. In some configurations, the connecting rod is coupled to a portion of a crankshaft. In some configurations, the crankshaft is positioned at least partially within the first opening of at least one of the adjacent bearing plates forming the receptacle.

Some configurations of the present frame assembly comprise a plurality of bearing assemblies. In some configurations, each bearing assembly is positioned around a corresponding portion of a crankshaft. In some configurations, each bearing assembly is coupled to the first opening of at least one of the adjacent bearing plates forming the receptacle accommodating the plunger assembly coupled to the crankshaft.

In some configurations of the present frame assembly, two bearing plates of the plurality of bearing plates are outboard bearing plates. In some configurations, four bearing plates of the plurality of bearing plates are inboard bearing plates. In some configurations, each outboard bearing plate comprises a mounting plate coupled to the base portion.

Some configurations of the present frame assembly comprise a plurality of bearing plates. In some configurations, each bearing plate comprises a body portion. In some configurations, the body portion comprises a first opening for receiving a portion of a crankshaft assembly. In some configurations, the body portion extends from a circumference of the first opening. In some configurations, each bearing plate comprises a receptacle portion. In some configurations, the receptacle portion is coupled to the body portion and extends in a first direction. In some configurations, each bearing plate comprises a base portion. In some configurations, the base portion is coupled to the body portion and extends in a second direction. In some configurations, the base portion comprises a first extension portion. In some configurations, the first extension portion extends beyond the receptacle portion. In some configurations, the base portion comprises a second extension portion. In some configurations, the second extension portion extends beyond the circumference of the first opening to the first extension. In some configurations, the base portion comprises a second opening for receiving a structural support. In some configurations, the second opening is at least partially positioned on the first extension portion. In some configurations, the base portion comprises a third opening for receiving a structural support. In some configurations, the third opening is at least partially positioned on the second extension portion. In some configurations, the present frame assembly comprises a first structural support. In some configurations, the first structural support extends through the second opening of each of the plurality of bearing plates. In some configurations, the present frame assembly comprises a second structural support. In some configurations, the second structural support extends through the third opening of each of the plurality of bearing plates. In some configurations, the receptacle portions of adjacent bearing plates form receptacles to accommodate at least a portion of a crosshead assembly. In some configurations, the plurality of bearing plates are coupled together by the first structural support. In some configurations, the plurality of bearing plates are coupled together by the second structural support. In some configurations, the plurality of bearing plates are coupled together by the first and second structural supports.

Some configurations of the present frame assembly may be comprised by a pump. In some configurations, the pump comprises a fluid end and a power end coupled to the fluid end. In some configurations, the power end comprises the present frame assembly. In some configurations, the present frame assembly comprises a plurality of bearing plates. In some configurations, each bearing plate comprises a body portion. In some configurations, the body portion comprises a first opening for receiving a portion of a crankshaft assembly. In some configurations, the body portion extends from a circumference of the first opening. In some configurations, each bearing plate comprises a receptacle portion. In some configurations, the receptacle portion is coupled to the body portion and extends in a first direction. In some configurations, each bearing plate comprises a base portion. In some configurations, the base portion is coupled to the body portion and extends in a second direction. In some configurations, the base portion comprises a first extension portion. In some configurations, the first extension portion extends beyond the receptacle portion. In some configurations, the base portion comprises a second extension portion. In some configurations, the second extension portion extends beyond the circumference of the first opening to the first extension. In some configurations, the base portion comprises a second opening for receiving a structural support. In some configurations, the second opening is at least partially positioned on the first extension portion. In some configurations, the base portion comprises a third opening for receiving a structural support. In some configurations, the third opening is at least partially positioned on the second extension portion. In some configurations, the present frame assembly comprises a first structural support. In some configurations, the first structural support extends through the second opening of each of the plurality of bearing plates. In some configurations, the present frame assembly comprises a second structural support. In some configurations, the second structural support extends through the third opening of each of the plurality of bearing plates. In some configurations, the receptacle portions of adjacent bearing plates form receptacles to accommodate at least a portion of a crosshead assembly. In some configurations, the plurality of bearing plates are coupled together by the first structural support. In some configurations, the plurality of bearing plates are coupled together by the second structural support. In some configurations, the plurality of bearing plates are coupled together by the first and second structural supports.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means “and” or “or.” To illustrate, A, B, and/or C includes: A alone, B alone, C alone, a combination of A and B, a combination of A and C, a combination of B and C, or a combination of A, B, and C. In other words, “and/or” operates as an inclusive or. The phrase “A, B, C, or a combination thereof” includes A alone, B alone, C alone, a combination of A and B, a combination of A and C, a combination of B and C, or a combination of A, B, and C. In other words, “or” is used inclusively unless otherwise is expressly specified.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any implementation of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, it will be understood that the term “wherein” may be used interchangeably with “where.”

Further, a device or system that is configured in a certain way is configured in at least that way, but it can also be configured in other ways than those specifically described. Aspects of one example may be applied to other examples, even though not described or illustrated, unless expressly prohibited by this disclosure or the nature of a particular example. Some details associated with the aspects described above and others are described below.

Some details associated with the aspects are described above, and others are described below. Other implementations, advantages, and features of the present disclosure will become apparent after review of the entire application, including the following sections: Brief Description of the Drawings, Detailed Description, and the Claims.

### BRIEF DESCRIPTION OF THE DRAWINGS

These drawings illustrate by way of example and not limitation. For the sake of brevity and clarity, every feature of a given structure is not always labeled in every figure in which that structure appears. Identical reference numbers do not necessarily indicate the same structure. Rather, the same reference number may be used to indicate a similar feature or a feature with similar functionality, as may non-identical reference numbers.

FIG. 1 is a side, cross-section view of a reciprocating pump according to some aspects of this disclosure.

FIG. 2A is a side view of a first example of a bearing plate according to some aspects of this disclosure.

FIG. 2B is a side view of a second example of a bearing plate according to some aspects of this disclosure.

FIG. 3 is a plan view of a first example of a frame assembly according to some aspects of this disclosure.

FIG. 4 is a plan view of a second example of a frame assembly according to some aspects of this disclosure.

### DETAILED DESCRIPTION OF ILLUSTRATIVE ASPECTS

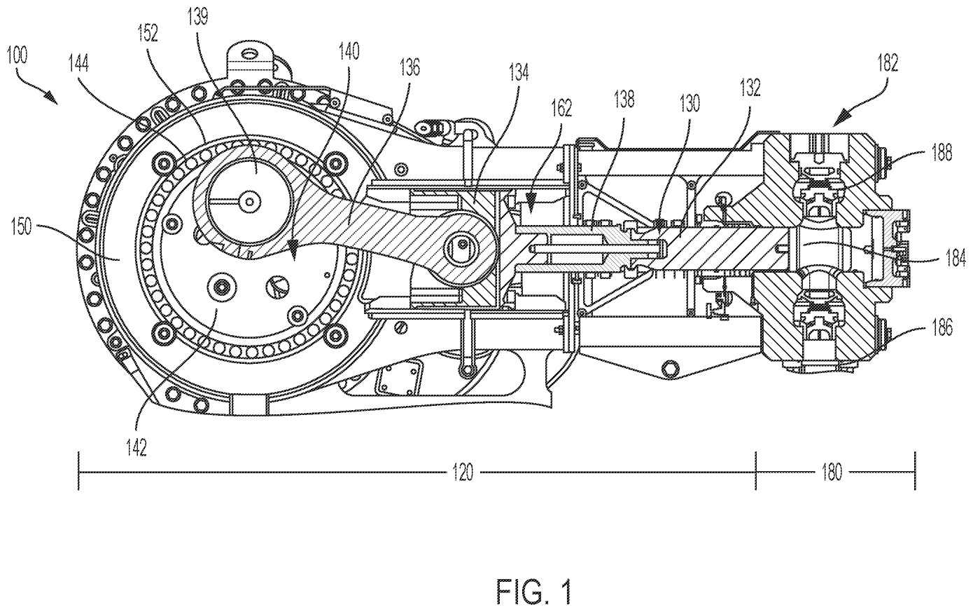

Referencing FIG. 1, a reciprocating pump 100 is shown. Reciprocating pump 100 includes two sections: a power end 120 and a fluid end 180. Power end 120 is configured to move one or more plungers toward, and away from, fluid end 180. Fluid end 180 is where the pumping takes place-fluid is drawn in and forcibly pushed out at a high pressure by the plungers.

Power end 120 includes a plurality of plunger assemblies 130, a plurality of crankshaft assemblies 140, and a power end frame assembly having a plurality of bearing plates 150. Because FIG. 1 is a side, cross-section view of reciprocating pump 100, only one plunger assembly 130, crankshaft assembly 140, and bearing plate 150 is shown. Each plunger assembly 130 includes a plunger 132, a crosshead 134, and a connecting rod 136. Plunger 132 is coupled to crosshead 134 via a ponyrod 138. Connecting rod 136 couples crosshead 134 to crankshaft assembly 140 via rod caps 139. Each crankshaft assembly 140 has at least a portion partially positioned within an opening 152 on bearing plate 150 and includes a crankshaft 142 and a crankshaft bearing 144 around crankshaft 142. Crankshaft bearing 144 is supported by opening 152 and couples crankshaft 142 to bearing plate 150 while allowing crankshaft 142 to rotate within opening 152. Adjacent bearing plates 150 of the power end frame assembly form receptacles 162 that accommodate crosshead 134 and configure crosshead 134 to displace linearly as crankshaft 142 rotates. Fluid end 180 includes a chamber 182 having a cylinder 184, a suction header 186, and a discharge valve 188. Reciprocating pump 100 increases pressure of the fluid in cylinder 184 by reciprocating plunger 132 longitudinally within cylinder 184. As a result, low-pressure fluid enters cylinder 184 via suction header 186 and high-pressure fluid exits cylinder 184 via discharge valve 188.

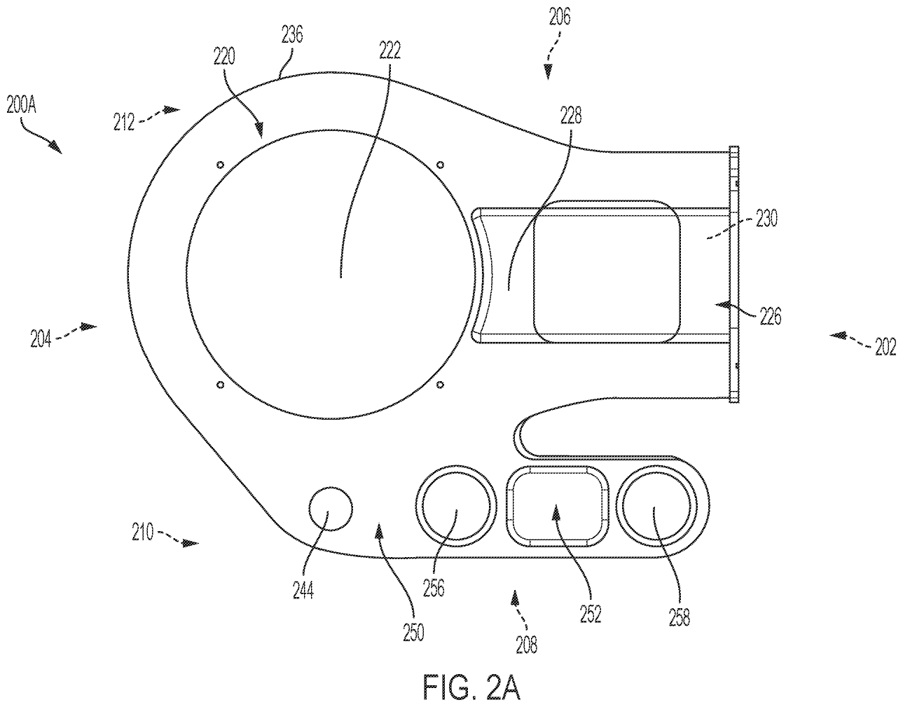

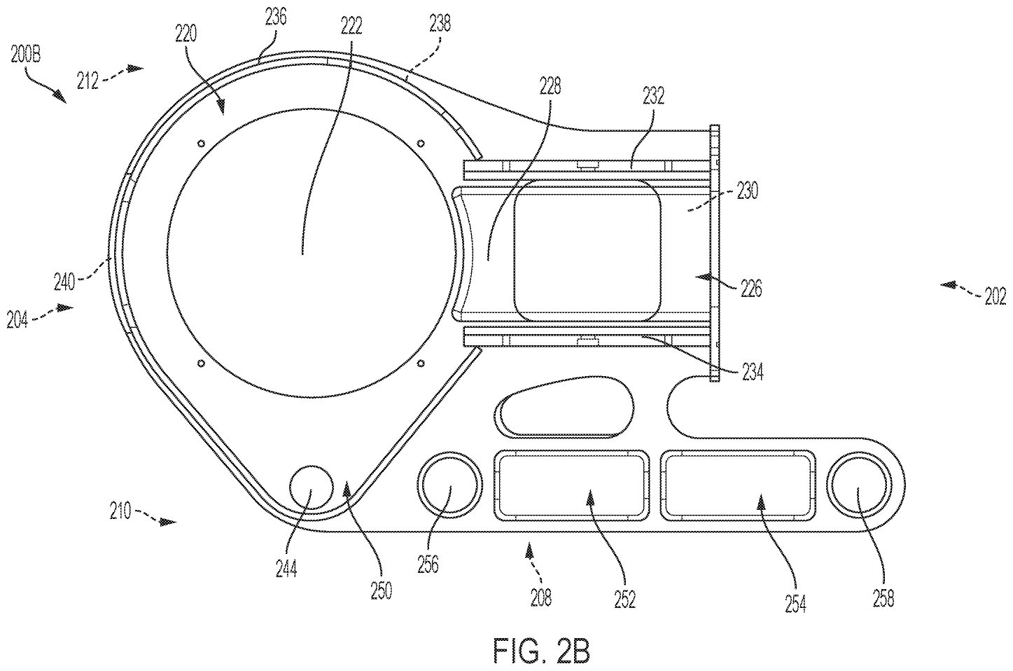

Referring to FIG. 2A, a bearing plate 200A is shown. Bearing plate 200A has a front side 202, a back side 204, a top side 206, a bottom side 208, a right side 210, and a left side 212 (not visible). In the shown configuration, the front side corresponds to the side of the bearing plate closest to the fluid end of the reciprocating pump when the bearing plate is part of a pump assembly—while the back side corresponds to the side opposite the front side (i.e., furthest from the fluid end). And in the shown configuration, the bottom side corresponds to the side of the bearing plate closest to the ground or platform when the bearing plate is part of a pump assembly—while the top side corresponds to the side opposite the bottom side (i.e., furthest from the ground or platform). As for the right and left sides in the shown configuration, these correspond to the right and left sides from a back-side point of view.

Bearing plate 200A includes a body portion 220, a receptacle portion 226, and a base portion 250.

As shown in FIG. 2A, body portion 220 has a first opening 222 and extends from a circumference of first opening 222. First opening 222 may be configured to receive and/or support a crankshaft assembly (e.g., 140). In some configurations, first opening 222 may be configured to receive and/or support a crankshaft bearing positioned around a portion of a crankshaft. In some configurations, the crankshaft bearing may couple the crankshaft to bearing plate 200A while allowing the crankshaft to rotate within first opening 222.

Receptacle portion 226 is coupled to body portion 220 and extends in a first direction. In the FIG. 2A configuration, receptacle portion 226 extends away from first opening 222 and towards front side 202 of bearing plate 200A. Receptacle portion 226 has a first receptacle surface 228 on right side 210 of bearing plate 200A and a second receptacle surface 230 (not visible) on left side 212 of bearing plate 200A. Receptacle portion 226 may have only first receptacle surface 228 in some configurations—and receptacle portion 226 may have only second receptacle surface 230 in other configurations.

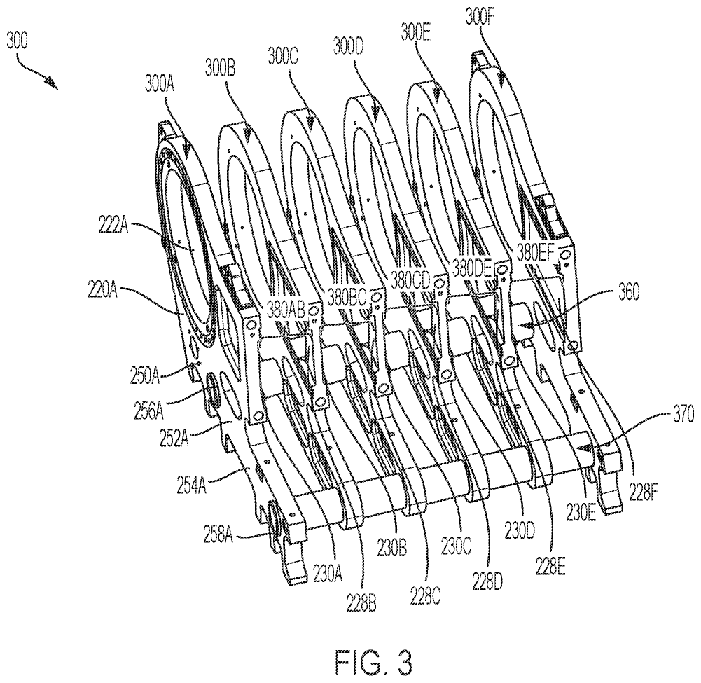

Receptacle portions are referred to as receptacle portions because, as shown in FIGS. 3A-B below (e.g., bearing plates 300A-F), together with the receptacle portions of adjacent bearing plates, they form receptacles that can accommodate at least a portion of one or more components of a crosshead assembly (e.g., crosshead 134).

Base portion 250 is coupled to body portion 220 and extends in a second direction. In the configuration shown in FIG. 2A, base portion 250 is coupled to body portion 220 near a bottom and extends towards front side 202 of bearing plate 200A. As shown in FIG. 2A, base portion 250 extends beyond the boundary (e.g., circumference) of first opening 222 and ends short of the end of receptacle portion 226 (in the first direction). In the shown configuration, base portion 250 has a first extension portion 252 that includes the portion of base portion 250 beyond the boundary of first opening 222 (in the second direction). Base portion 250 has a second opening 256 and a third opening 258. Second and third openings 256, 258 may be configured to receive a structural support. In the configuration shown in FIG. 2A, second opening 256 is partially positioned on first extension portion 252 and third opening 258 is totally positioned on first extension portion 252. And in the FIG. 2A configuration, the centers of second and third openings 256, 258 are aligned with each other. In some configurations, the second opening, the third opening, or both have a center vertically aligned with at least one of a portion of the receptacle portion and a portion of the body portion positioned between the boundary of the first opening and the receptacle portion.

Referring to FIG. 2B, a bearing plate 200B is shown. Bearing plate 200B is substantially similar to bearing plate 200A except that bearing plate 200B has a base portion 250 that extends beyond receptacle portion 226 and bearing plate 200B includes a first crosshead support plate 232, a second crosshead support 234, a crankcase 236, and an oil drain hole 244.

As shown in FIG. 2B, base portion 250 is coupled to body portion 220 and receptacle portion 226 and extends beyond receptacle portion 226. In the configuration shown in FIG. 2B, base portion 250 has a second extension portion 254 that includes the portion of base portion 250 beyond the receptacle portion 226 (in the second direction). In the configuration illustrated in FIG. 2B first extension portion 252 includes the portion of base portion 250 beyond the boundary of first opening 222 (in the second direction) up to second extension portion 254. In the FIG. 2B configuration, second opening 256 is partially positioned on first extension portion 252 and third opening 258 is totally positioned on second extension portion 254. As with the FIG. 2A configuration, the centers of second and third openings 256, 258 are aligned with each other in the FIG. 2B configuration.

In the configuration shown in FIG. 2B, bearing plate 200B includes first crosshead support plate 232, second crosshead support 234, crankcase 236, and oil drain hole 244. First crosshead support plate 232 is coupled to first receptacle surface 228 near a top of receptacle portion 226 and a top of bearing plate 200B. And second crosshead support plate 234 is coupled to first receptacle surface 228 below—and aligned with—first crosshead support plate 232. First and second crosshead support plates 232, 234 may be configured to support a crosshead assembly (e.g., crosshead 134). Crankcase 236 is coupled at one end to first crosshead support plate 232 and at an opposite end to second crosshead support plate 234. In the FIG. 2B configuration, crankcase 236 extends from first crosshead support plate 232 to second crosshead support plate 234 and around first opening 222. Crosshead support plates 232, 234 and crankcase 236 may help bearing plate 200B and/or the power end frame assembly resist, for example, deflection. Crankcase 236 may have a first access opening 238 (not visible) and a second access opening 240 (not visible) extending through crankcase 236. Access openings 238, 240 may allow access to internal components, such as a crankshaft assembly (e.g., 140), when bearing plate 200B is part of a power end frame and/or pump assembly. In the configuration shown in FIG. 2B, oil drain hole 244 is positioned on base portion 250, oil drain hole 244 is within the boundary of crankcase 236, and a portion of crankcase 236 is coupled to a portion of base portion 250. In the FIG. 2B configuration, second and third openings 256, 258 are outside of the boundary of crankcase 236.

Referring to FIG. 3, a power end frame assembly 300 is shown. Power end frame assembly 300 includes first outboard bearing plate 300A; first, second, third, and fourth inboard bearing plates 300B-E; and second outboard bearing plate 300F. Inboard bearing plates 300B-E are substantially similar to bearing plate 200B. Likewise, outboard and inboard bearing plates 300A, 300F are substantially similar to bearing plate 200 with the addition that outboard bearing plates 300A, 300F are configured to couple to a supporting skid, platform, or base structure (e.g., pump mounting plates) and to rigging and/or lifting equipment. In the configuration illustrated in FIG. 3, bearing plates 300A-F are approximately parallel or parallel relative to each other.

Power end frame assembly 300 also includes first receptacle 380AB, second receptacle 380BC, third receptacle 380CD, fourth receptacle 380DE, and fifth receptacle 380EF. First receptacle 380AB, second receptacle 380BC, third receptacle 380CD, fourth receptacle 380DE, and fifth receptacle 380EF are each configured to accommodate at least a portion of one or more components of a crosshead assembly (e.g., crosshead 134). First receptacle 380AB is formed by receptacle surfaces 230A and 228B; second receptacle 380BC is formed by receptacle surfaces 230B and 228C; third receptacle 380CD is formed by receptacle surfaces 230C and 228D; fourth receptacle 380DE is formed by receptacle surfaces 230D and 228E; and fifth receptacle 380EF is formed by receptacle surfaces 230E and 228F.

Power end frame assembly 300 also includes first structural support 360 and second structural support 370. First structural support 360 is received by second openings 256A-F of bearing plates 300A-F. In the configuration shown, bearing plates 300A-F are coupled together by first structural support 360. Similarly, second structural support 370 is received by third openings 258A-F of bearing plates 300A-F. Although structural supports 360, 370 are shown as circular tubes, the supports may take other shapes, such as squares or rectangles. Further, the structural supports 360, 370 may be hollow or solid. In the configuration shown, bearing plates 300A-F are coupled together by second structural support 370. In the configurations shown in FIG. 3, each opening 256A-F, 258A-F is on a respective base portion 250A-F that is coupled to a respective body portion 220A-F and that extends beyond the receptacle or receptacles (e.g., 380AB, 380BC, 380CD, 380DE, and 380EF) formed by a respective bearing plate (300A-F) and an adjacent bearing plate or plates.

Individually, first structural support 360 and second structural support 370 help resist twisting of the bearing plates and undergo loads in torsion, bending, and shear. Together, structural supports 360, 370 can form a boxlike structure that further reinforces the frame assembly. In the shown configuration, only the outboarding bearing plates are configured to couple to a supporting skid, platform, base structure, or the like. By using the structural supports to absorb resulting loads and reducing the number of touch points between bearing plates and base structures, potential failure points are eliminated but performance of the power end and reciprocating pump are maintained and/or improved.

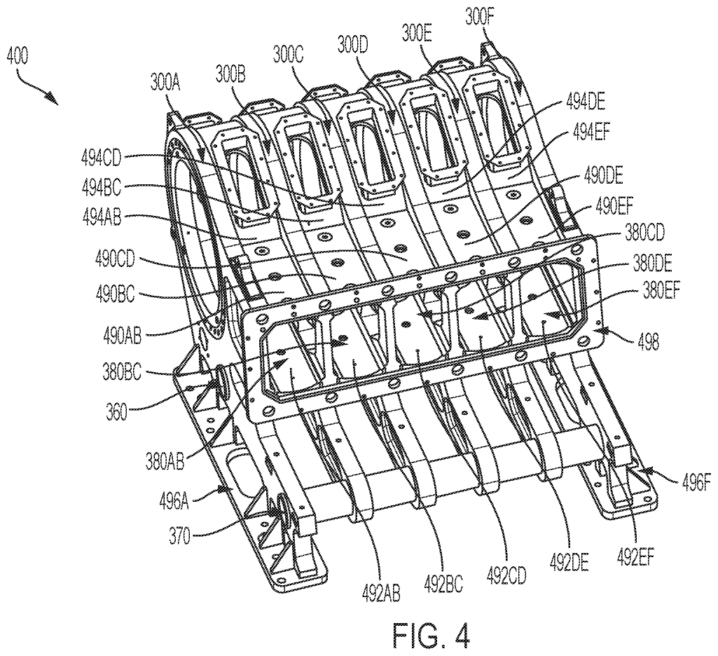

Referring to FIG. 4, a power end frame assembly 400 is shown. Power end frame assembly 400 is substantially similar to power end frame assembly 300 except that power end frame assembly 400 further includes first crosshead support plates 490AB, 490BC, 490CD, 490DE, and 490EF; second crosshead support plates 492AB, 492BC, 492CD, 492DE, and 492EF; crankcases 494AB, 494BC, 494CD, 494DE, and 494EF; mounting flanges 496A and 496F; and noseplate mounting flange 498.

In the configuration shown, each receptacle further includes a first crosshead support plate and a second crosshead support plate. First receptacle 380AB further includes first crosshead support plate 490AB and second crosshead support plate 492AB; second receptacle 380BC further includes first crosshead support plate 490BC and second crosshead support plate 492BC; third receptacle 380CD further includes first crosshead support plate 490CD and second crosshead support plate 492CD; fourth receptacle 380DE further includes first crosshead support plate 490DE and second crosshead support plate 492DE; and fifth receptacle 380EF further includes first crosshead support plate 490EF and second crosshead support plate 492EF.

First crosshead support plates 490AB, 490BC, 490CD, 490DE, and 490EF are substantially similar to first crosshead support plate 232 except that each first crosshead support plate 490AB, 490BC, 490CD, 490DE, and 490EF is coupled on one side to a first receptacle surface 228 of one of bearing plates 300A-F and on an opposite side to a second receptacle surface 230 of another one of bearing plates 300A-F. For example, first crosshead support plate 490AB is coupled to receptacle surfaces 230A and 228B; first crosshead support plate 490BC is coupled to receptacle surfaces 230B and 228C; first crosshead support plate 490CD is coupled to receptacle surfaces 230C and 228D; first crosshead support plate 490DE is coupled to receptacle surfaces 230D and 228E; and first crosshead support plate and 490EF is coupled to receptacle surfaces 230E and 228F.

Second crosshead support plates 492AB, 492BC, 492CD, 492DE, and 492EF are substantially similar to second crosshead support plate 234 except that each second crosshead support plate 492AB, 492BC, 492CD, 492DE, and 492EF is coupled on one side to a first receptacle surface 228 of one of bearing plates 300A-F and on an opposite side to a second receptacle surface 230 of another one of bearing plates 300A-F. For example, second crosshead support plate 492AB is coupled to receptacle portions 230A and 228B; second crosshead support plate 492BC is coupled to receptacle portions 230B and 228C; second crosshead support plate 492CD is coupled to receptacle portions 230C and 228D; second crosshead support plate 492DE is coupled to receptacle portions 230D and 228E; and second crosshead support plate and 492EF is coupled to receptacle portions 230E and 228F.

Crankcases 494AB. 494BC, 494CD, 494DE, and 494EF are substantially similar to crankcase 236 except that each of crankcases 494AB, 494BC, 494CD, 494DE, and 494EF is coupled on one side to a right side 210 of one of bearing plates 300A-F and on an opposite side to a left side 212 of another one of bearing plates 300A-F and that each of crankcases 494AB, 494BC, 494CD, 494DE, and 494EF extends around first opening 222 of the two bearing plates 300A-F to which it is coupled. Crankcase 494AB is coupled to first crosshead support plate 490AB and to second crosshead support plate 492AB; and crankcase 494AB is coupled to bearing plates 300A and 300B. Crankcase 494AB may also extend around first openings 222A and 222B of bearing plates 300A and 300B. Crankcase 494BC is coupled to first crosshead support plate 490BC and to second crosshead support plate 492BC; and crankcase 494BC is coupled to bearing plates 300B and 300C. Crankcase 494BC may also extend around first openings 222B and 222C of bearing plates 300B and 300C. Crankcase 494CD is coupled to first crosshead support plate 490CD and to second crosshead support plate 492CD; and crankcase 494CD is coupled to bearing plates 300C and 300D. Crankcase 494CD may also extend around first openings 222C and 222D of bearing plates 300C and 300D. Crankcase 494DE is coupled to first crosshead support plate 490DE and to second crosshead support plate 492DE; and crankcase 494DE is coupled to bearing plates 300D and 300E. Crankcase 494DE may also extend around first openings 222D and 222E of bearing plates 300D and 300E. Crankcase 494EF is coupled to first crosshead support plate 490EF and to second crosshead support plate 492EF; and crankcase 494EF is coupled to bearing plates 300E and 300F. Crankcase 494EF may also extend around first openings 222E and 222F of bearing plates 300E and 300F. In the configuration shown in FIG. 4, both structural supports 360, 370 are positioned outside of the boundaries formed by crankcases 494 and crosshead support plates 490, 492. In the configuration illustrated in FIG. 4, structural support 370 is farther from first openings 222 than receptacles 380, while structural support 360 is closer to first openings 222 than portions of receptacles 380.

The above specification and examples describe the structure and use of illustrative implementations. Although certain examples have been described above with some particularity, or with reference to one or more individual examples, those skilled in the art could make numerous alterations to the disclosed implementations without departing from the scope of this invention. So the various illustrative implementations of the methods and systems are not intended to be limited to the particular forms disclosed. Rather, they include all modifications and alternatives falling within the scope of the claims, and examples other than the one shown may include some or all of the features of the depicted example. For example, elements may be omitted or combined as a unitary structure, and/or connections may be substituted. Further, where appropriate, aspects of any of the examples described above may be combined with aspects of any of the other examples described to form more examples having comparable or different properties and/or functions and addressing the same or different problems. Similarly, it will be understood that the benefits and advantages described above may relate to one embodiment or may relate to several implementations.

The claims are not intended to include, and should not be interpreted to include, means-plus- or step-plus-function limitations, unless such a limitation is explicitly recited in each claim using the phrase(s) “means for” or “step for,” respectively.

What is claimed is:

1. A frame assembly comprising:
a plurality of bearing plates, each bearing plate comprising:
a body portion comprising a first opening for receiving a portion of a crankshaft assembly, the body portion extending from a circumference of the first opening;
a receptacle portion coupled to the body portion and extending in a first direction; and
a base portion coupled to the body portion and extending in a second direction, the base portion comprising an extension portion that extends beyond the circumference of the first opening and a second opening for receiving a structural support, the second opening at least partially positioned on the extension portion; and
a structural support extending through the second opening of each of the plurality of bearing plates,
wherein:
the receptacle portions of adjacent bearing plates form receptacles to accommodate at least a portion of a crosshead assembly, and
the plurality of bearing plates are coupled together by the structural support.

2. The frame assembly of claim 1, wherein the extension portion has a portion that extends beyond the receptacle portion and the second opening is positioned on the portion of the extension portion that extends beyond the receptacle portion.

3. The frame assembly of claim 1, wherein the structural support is a first structural support, the base portion further comprises a third opening for receiving a structural support, the frame assembly further comprises a second structural support extending through the third opening of each of the plurality of bearing plates, and the plurality of bearing plates are coupled together by the second structural support.

4. The frame assembly of claim 3, wherein the third opening is positioned on the extension portion.

5. The frame assembly of claim 4 wherein the extension portion has a portion that extends beyond the receptacle portion and the third opening is positioned on the portion of the extension portion that extends beyond the receptacle portion.

6. The frame assembly of claim 1, wherein the extension portion comprises a first extension portion extending beyond the receptacle portion and a second extension portion extending beyond the circumference of the first opening to the first extension portion.

7. The frame assembly of claim 6, wherein the structural support is a first structural support, the base portion further comprises a third opening for receiving a structural support, the frame assembly further comprises a second structural support extending through the third opening of each of the plurality of bearing plates, and the plurality of bearing plates are coupled together by the second structural support.

8. The frame assembly of claim 7, wherein the second opening is positioned on the second extension portion and the third opening is positioned on the first extension portion.

9. The frame assembly of claim 8, wherein the second and third openings are positioned on the first extension portion.

10. The frame assembly of claim 1, wherein the structural support comprises a tubular beam having a hollow body with a circular cross-section.

11. The frame assembly of claim 1, wherein each receptacle comprises a first crosshead plate and a second crosshead plate, and wherein the crosshead plates are coupled to the adjacent bearing plates that form the receptacle.

12. The frame assembly of claim 11, wherein the frame assembly further comprises one or more crankcase casing plates that correspond to respective receptacles formed by adjacent bearing plates of the frame assembly, wherein each crankcase casing plate is coupled to the first crosshead plate, the second crosshead plate, and the adjacent bearing plates of the respective receptacle, and wherein each crankcase casing plate extends from the first crosshead plate to the second crosshead plate and around the first opening of the adjacent bearing plates of the respective receptacle.

13. The frame assembly of claim 12, wherein each crankcase casing plate further comprises one or more openings for allowing access to one or more components of at least one of a crankshaft assembly, a bearing assembly, a plunger assembly, and a crosshead assembly.

14. The frame assembly of claim 13, further comprising a plurality of crossheads, wherein each crosshead is at least partially positioned within a corresponding receptacle.

15. The frame assembly of claim 14, further comprising a plurality of plunger assemblies, wherein each plunger assembly of the plurality of plunger assemblies comprises a plunger coupled to a crosshead of the plurality of crossheads and extends beyond the receptacle.

16. The frame assembly of claim 15, wherein each plunger assembly further comprises a connecting rod coupled to the crosshead and to a portion of a crankshaft positioned at least partially within the first opening of at least one of the adjacent bearing plates forming the receptacle.

17. The frame assembly of claim 16, further comprising a plurality of bearing assemblies, wherein each bearing assembly is positioned around a corresponding portion of a crankshaft and coupled to the first opening of at least one of the adjacent bearing plates forming the receptacle accommodating the plunger assembly coupled to the crankshaft.

18. The frame assembly of claim 1, wherein two bearing plates of the plurality of bearing plates are outboard bearing plates, four bearing plates of the plurality of bearing plates are inboard bearing plates, and wherein each outboard bearing plate further comprises a mounting plate coupled to the base portion.

19. A frame assembly comprising:
a plurality of bearing plates, each bearing plate comprising:
a body portion comprising a first opening for receiving a portion of a crankshaft assembly, the body portion extending from a circumference of the first opening;
a receptacle portion coupled to the body portion and extending in a first direction; and
a base portion coupled to the body portion and extending in a second direction, the base portion comprising a first extension portion that extends beyond the receptacle portion, a second extension portion that extends beyond the circumference of the first opening to the first extension, a second opening for receiving a structural support at least partially positioned on the first extension portion, and a third opening for receiving a structural support at least partially positioned on the second extension portion;
a first structural support extending through the second opening of each of the plurality of bearing plates; and
a second structural support extending through the third opening of each of the plurality of bearing plates,
wherein:
the receptacle portions of adjacent bearing plates form receptacles to accommodate at least a portion of a crosshead assembly, and the plurality of bearing plates are coupled together by the first and second structural supports.

20. A reciprocating pump comprising:
a fluid end; and
a power end coupled to the fluid end and comprising a frame assembly;
wherein the frame assembly comprises:
a plurality of bearing plates, each bearing plate comprising:
a body portion comprising a first opening for receiving a portion of a crankshaft assembly, the body portion extending from a circumference of the first opening;
a receptacle portion coupled to the body portion and extending in a first direction; and
a base portion coupled to the body portion and extending in a second direction, the base portion comprising a first extension portion that extends beyond the receptacle portion, a second extension portion that extends beyond the circumference of the first opening to the first extension, a second opening for receiving a structural support at least partially positioned on the first extension portion, and a third opening for receiving a structural support at least partially positioned on the second extension portion;
a first structural support extending through the second opening of each of the plurality of bearing plates; and
a second structural support extending through the third opening of each of the plurality of bearing plates,
wherein:
the receptacle portions of adjacent bearing plates form receptacles to accommodate at least a portion of a crosshead assembly, and the plurality of bearing plates are coupled together by the first and second structural supports.
